(19) United States
(12) Patent Application Publication
(10) Pub. No.: US 2011/0281232 A1
(43) Pub. Date: Nov. 17, 2011

(54) MEDICAL OR DENTAL HANDPIECE

(75) Inventors: Juergen Brandner, St. Georgen (AT); Michael Rothenwaender, Lamprechtshausen (AT)

(73) Assignee: W&H Dentalwerk Bürmoos GmbH

(21) Appl. No.: 13/109,805

(22) Filed: May 17, 2011

(30) Foreign Application Priority Data
May 17, 2010 (EP) 10162913

(51) Int. Cl. A61C 1/08

(52) U.S. Cl. 433/126

(57) ABSTRACT

A medical or dental handpiece comprises a grip sleeve, a handpiece head, an engagement element and a retaining member. The handpiece head comprises a head housing and a hollow connecting sleeve extending from the head housing for connecting the handpiece head to the grip sleeve. The engagement element has a first end positionable to extend through the grip sleeve and a second end engageable within an opening in the handpiece head. The retaining member is spaced proximally from the handpiece head. The first end of the engagement element is connectable with the retaining member to secure the second end of the engagement element against the handpiece head and to retain the grip sleeve around the engagement element and against the handpiece head.

### CROSS REFERENCE TO RELATED APPLICATION

The present application claims priority from pending European Patent Application No. 10162913 filed May 17, 2010, which is incorporated herein by reference.

### BACKGROUND

1. Field

The present application relates to a medical or dental handpiece and a method for manufacturing a handpiece.

2. Description of Prior Art

Such medical or dental handpieces are used to drive medical tools. Therefore the handpieces have a tool receptacle to receive the treatment tools in the handpiece. The tool receptacle is rotated by means of a turbine drive, which is preferably operated with compressed gas and has in particular a rotor arranged in the head. The head of the handpiece is preferably arranged at an angle to its handpiece part, thus yielding an angled dental piece. With such an angled arrangement of the handpiece head relative to its handpiece part, the handpiece is preferably designed in two parts and is connected by means of a connecting means situated in the handpiece.

Such a medical or dental handpiece is known from EP 1,157,670 B1.

This known turbine handpiece comprises a turbine head and a handpiece sleeve situated thereon as well as means for chucking both components. For this purpose, the handpiece sleeve has a carrier part, which is arranged on the end of the handpiece sleeve facing away from the turbine head. The connecting means, in particular a tension screw, extends away from the carrier part to the head part, where it is attached. The carrier part has a borehole and a contact face to receive the tension screw. The head part includes a shaft to mount the head in the handpiece sleeve. The shaft in turn has a bore with an inside thread for fastening the tension screw on the head part. Consequently, the head part can be chucked to the handpiece part via the carrier part by screwing the tension screw into the borehole of the shaft.

One disadvantage of this embodiment of the connection of the handpiece head to the handpiece sleeve of the medical handpiece, in particular an angled piece has proven to be the fastening of the connecting means, in particular the tension screw, to the instrument head. Because of the design of this connection as a screw connection, it is necessary to design the shaft part of the turbine head as a solid component. In addition to the borehole with an inside thread arranged therein to receive the tension screw, this shaft part has additional boreholes to supply the turbine head with various media such as spray air, spray water or light and to supply the rotor arranged in the head with driving air. In addition to these boreholes to receive the supply lines, the shaft part additionally has through-holes, which serve to return the driving air from the rotor receptacle of the turbine head through and/or into the interior of the handpiece sleeve. Due to the design of the shaft part as a solid component, the returning of the driving air from the rotor, in particular from the rotor receptacle, is limited only to the boreholes in the shaft part. This leads to a reduction in the power of the turbine drive due to the dynamic pressures that are generated between the rotor and the rotor receptacle and the shaft part.

The tension screw as another component installed in the handpiece constitutes another disadvantage of the embodiment known in the state of the art. Due to the arrangement of the tension screw in the interior of the handpiece, the cross section of the return air line, which is formed through the sleeve-shaped handpiece part, next to the supply lines is additionally reduced. This also leads to a reduction in the power of the turbine drive due to the dynamic pressures built up.

It would be advantageous to create a medical or dental handpiece, which avoids the disadvantages of the state of the art while being easy to manufacture and which in particular makes it possible to connect parts of the handpiece easily and in a space-saving manner.

### SUMMARY

According to one exemplary embodiment of a medical or dental handpiece having a grip sleeve, a handpiece head as well as means for chucking the grip sleeve with the handpiece head with a connecting element and a chucking element provided in the grip sleeve and connectable to the connecting element, the handpiece head has a head housing and a hollow connecting sleeve connected thereto for connecting the handpiece head to the grip sleeve, wherein the connecting element has a driving air tube, which extends from the chucking element into the handpiece head and the outside diameter of the end of the driving air tube extending in the handpiece head is larger than the inside diameter of the hollow connecting sleeve of the handpiece head, so that the driving air tube comes in contact with or engages behind the handpiece head and chucks the handpiece head with the grip sleeve via the chucking element mounted in the grip sleeve against a stop.

According to one exemplary embodiment, the chucking element arranged on the end of the grip sleeve opposite the handpiece head is designed as a carrier plate for at least one driving air tube accommodated in the grip sleeve. The handpiece head itself consists of a head housing and a hollow connecting sleeve for connecting the handpiece head to the grip sleeve of the handpiece. The driving air tube accommodated by means of the carrier plate in the grip sleeve serves as a connecting part for chucking the handpiece head to the grip sleeve. For this purpose, the end of the driving air tube extending in the handpiece head has an outside diameter, which is larger than the inside diameter of the hollow connecting sleeve of the handpiece head.

The driving air tube itself is preferably designed in two parts as a nozzle piece and as a tube piece, wherein the nozzle piece extends in the handpiece head. Preferably several channels which distribute driving air from at least one inlet opening to preferably at least two outlet openings are arranged in the interior of the nozzle piece. The end of the nozzle piece having at least two outlet openings forms a part of the cylindrical rotor receptacle and, for this purpose, is in the shape of an arc of a circle in particular.

A coupling sleeve is preferably connected to the grip sleeve of the handpiece, such that the carrier plate accommodating the driving air tube in the handpiece may be arranged in the grip sleeve or in the coupling sleeve.

The handpiece head and the hollow connecting sleeve surround a shared space to receive a turbine drive, in particular the rotor and the supply lines for driving air. The driving air tube serves as a supply of driving air in the rotor receptacle of the head housing and the sleeve-shaped connecting sleeve and the grip sleeve of the handpiece serve as a return line for the driving air.

To chuck the handpiece head with the grip sleeve via the driving air tube and the chucking element, the hollow connecting sleeve or the head housing of the handpiece head has a second diameter, which corresponds to the outside diameter of the driving air tube, in particular the nozzle piece and, together with the inside diameter of the hollow connecting sleeve of the handpiece head, forms at least one contact surface for the driving air tube.

According to one exemplary embodiment, the chucking element has a carrier plate and a hollow screw. The hollow screw, in particular a nut having an inside thread, engages a thread, in particular an outside thread of the driving air tube and thus chucks the driving air tube against the carrier plate, which in turn is supported against a stop in the grip sleeve.

According to one exemplary embodiment, the sleeve wall of the hollow connecting sleeve is provided with at least one interruption and/or with at least one recess to enlarge the return air opening so as to minimize the dynamic pressure of the return air.

To produce the medical or dental handpiece described here, the driving air tube, which serves as the connecting means, including a first end and a second end, where the second end has an outside diameter, which is larger than the inside diameter of the hollow connecting sleeve of the handpiece head, first by inserting the first end of the driving air tube through the hollow connecting sleeve and applying the second end of the driving air tube to at least one contact surface on the handpiece head. Next, the grip sleeve of the handpiece head is placed on the connecting sleeve of the handpiece head. After connecting the chucking element to the driving air tube, the chucking element is supported against a stop in the grip sleeve of the handpiece, so that the handpiece head is chucked with the grip sleeve of the handpiece.

The present medical or dental handpiece is characterized by a number of substantial advantages.

Due to the design of the driving air tube as a connecting means for the handpiece head and the grip sleeve, no further connecting means for connecting the two components within the grip sleeve of the handpiece and thus in the return line is necessary. This does not lead to a reduction in cross section of the return air line and consequently to a reduction in the resulting dynamic pressures in the return air line, so the power of the turbine drive is increased.

In addition, no receptacle, in particular no solid shaft with a borehole for a screw connection is necessary on the handpiece head, preferably on its connecting sleeve, to attach the connecting means to the handpiece head. By chucking the handpiece head to the grip sleeve of the handpiece by means of the driving air tube, which has an outside diameter larger than the inside diameter of the hollow connecting sleeve, the connecting sleeve on the handpiece head may be designed to be hollow so that the opening for the driving air flowing out from the rotor on the handpiece head can be enlarged. Consequently, this leads to a reduction in the resulting dynamic pressures in the rotor receptacle of the handpiece head, so that the power of the turbine drive is also increased.

The multipart, in particular two-part, design of the driving air tube forms another advantage of the invention. By designing the driving air tube as a nozzle piece and a tube piece, it is possible to provide boreholes, in particular driving air channels and oncoming flow openings, which would usually be provided in the head housing and/or in the shaft part of the handpiece head, in the nozzle piece. Due to the arrangement of the channels in a separate component, driving air channels can be manufactured with multiple branches and changes in direction and integrated into the handpiece head.

Within the scope of the invention, it is self-evident that the medical or dental handpiece is not limited to angled handpieces. The term handpiece instead comprises all straight pistol-shaped handpieces as well as parts of handpieces having a tool receptacle to receive a treatment tool.

The invention is explained in greater detail below in conjunction with the accompanying drawings.

### BRIEF DESCRIPTION OF THE DRAWINGS

FIG. 1 shows a longitudinal section through an exemplary embodiment of a medical or dental handpiece in a side view.

FIG. 2 shows a longitudinal section through the medical or dental handpiece from FIG. 1, as seen from above.

FIG. 3 shows the driving air tube of the medical or dental handpiece from FIG. 1.

FIG. 4 shows a cross section through the medical or dental handpiece along line Q-Q.

FIG. 5 shows a cross section through the medical or dental handpiece along line R-R, together with a coupling sleeve.

### DETAILED DESCRIPTION

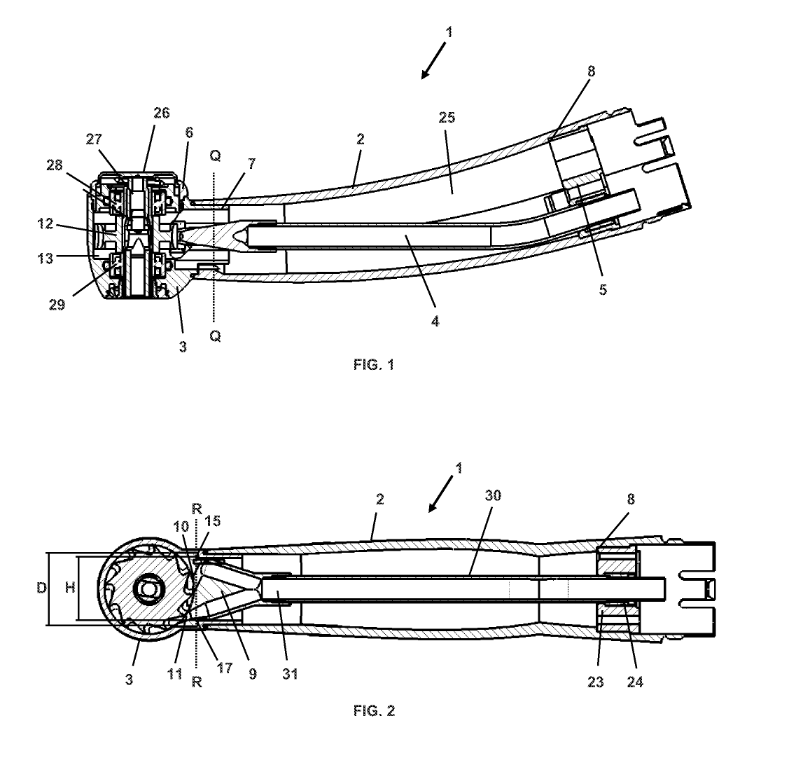

The medical or dental handpiece 1 shown in FIG. 1 is designed as an angled piece having a grip sleeve 2 and a handpiece head 3 arranged at an angle thereon. The handpiece head 3 itself has a head housing 6 and a hollow connecting sleeve 7 to receive a turbine drive, in particular a rotor 12, in an essentially cylindrical rotor receptacle 13 as well as a pushbutton 26 for operating a tool receptacle 27. The rotor 12 together with the tool receptacle 27 is rotatably mounted in the rotor receptacle 13 by means of an upper and lower bearing 28, 29. A driving air tube 4, which serves to supply the driving air to the rotor 12 of the turbine drive, is accommodated in the grip sleeve 2. The driving air tube 4 itself is designed as part of a connecting element or engagement element to chuck or couple the handpiece head 3 with the grip sleeve 2 together with the chucking or retainer element 5, which is supported against a stop 8 and at the same time serves to position the driving air tube 4 in the grip sleeve 2. The return air line 25 formed through the grip sleeve 2 of the handpiece 1 and the driving air tube 4 serves to return the driving air flowing out of the rotor 12.

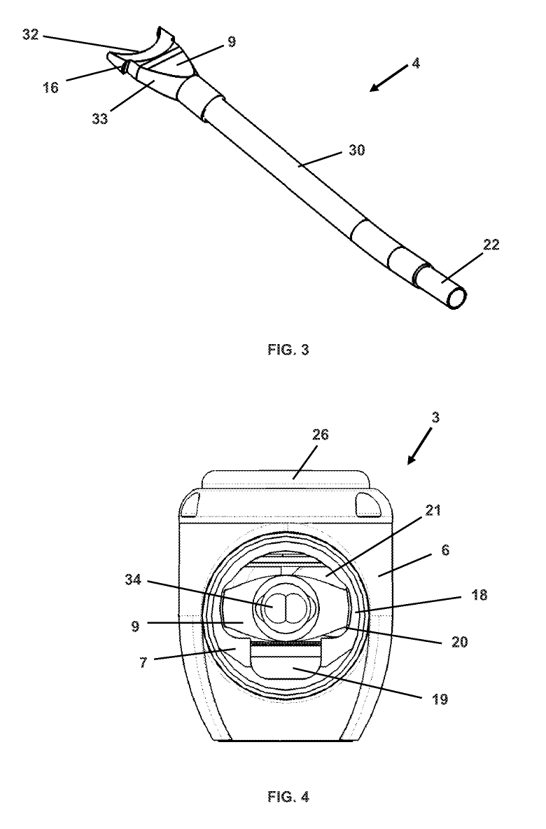

FIG. 2 shows a longitudinal section through the medical or dental handpiece 1 in a view from above. The driving air tube 4 accommodated in the grip sleeve 2 by the carrier plate 23 is preferably designed in two parts, as a nozzle piece 9 and as a tube piece 30. The tube piece 30 here extends from the carrier plate 23 to the nozzle piece 9 and is preferably connected to it by a thread. The nozzle piece 9 itself has at least one inlet opening 31 for driving air and several outlet openings, in particular a first and a second outlet opening 10, 11, which guide the driving air from the tube piece 30 into the rotor receptacle 13, in particular onto the blades of the rotor 12. For connecting the handpiece head 3 to the grip sleeve 2, the driving air tube has an outside diameter or dimension D on the end extending in the handpiece head 3, which is larger than the inside diameter H of the hollow connecting sleeve 7 of the handpiece head 3. At least one setback 15 or 17 on the handpiece head forms at least one contact surface 15 for the driving air tube 4. Screwing the hollow screw 24, which is in contact with the carrier plate 23, onto a thread on the tube piece 30 of the driving air tube 4 results in an axial displacement of the driving air tube 4 with respect to the carrier plate 23 and/or with respect to the grip sleeve 2 of the handpiece 1 against the stop 8. Consequently, the handpiece head 3 is braced via the driving air tube 4 with the grip sleeve. The hollow screw 24 is therefore accommodated in a guide bore in the carrier plate 23. In addition to this bore, the carrier plate 23 and/or the chucking/retainer element 5 has/have additional boreholes to supply media such as spray air, spray water or light to the handpiece head 3 and bores to return the driving air flowing away from the rotor 12.

FIG. 3 shows the driving air tube 4, which serves as the connecting means or engagement element for the handpiece head 3 and the grip sleeve 2. The driving air tube 4 has a threaded area 22 on a first end, in particular on the free end of the pipe piece 30, which serves to engage the hollow screw 24. On the second end of the driving air tube 4, the nozzle piece 9 has an outside dimension D, which is larger than the inside diameter H of the hollow connecting sleeve of the handpiece head 1. This end is preferably formed by a part 32 in the form of an arc of a circle to form, together with the head housing, an essentially cylindrical rotor receptacle 13. The part 33 of the nozzle piece extending from the outside diameter D toward the rear in the direction of the tube piece 30 is preferably designed with a taper (i.e., wedge-shaped) and has at least one protrusion 16, which engages in the setback 15 or 17 in the handpiece head.

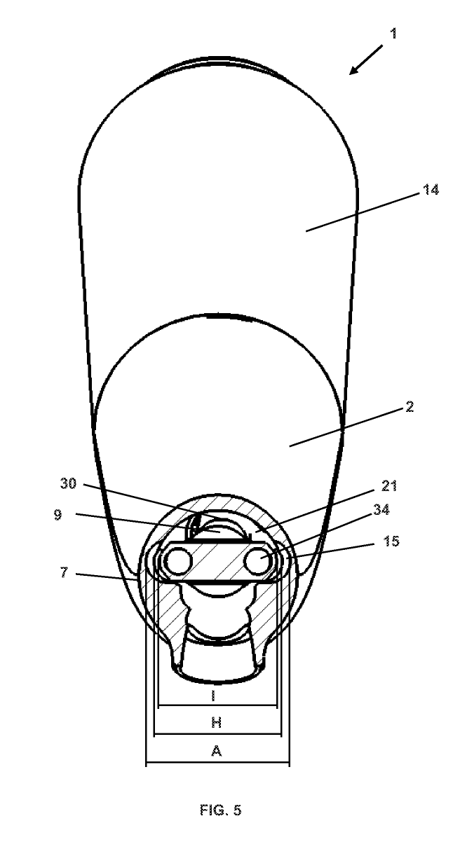

FIG. 4 shows a cross section through the medical or dental handpiece 1 along line Q-Q. The handpiece head 3 comprising the head housing 6 and the pushbutton 26 has a hollow connecting sleeve 7, which is connected to the head housing 6. The driving air tube 4, in particular its nozzle piece 9, extends through the hollow connecting sleeve 7 into the rotor receptacle 13 of the handpiece head 3. An opening 21 for the driving air flowing from the rotor 12, air having been supplied to the rotor 12 via the driving air tube 4, in particular via the nozzle piece 9 and the plurality of channels 34, is formed by the hollow connecting sleeve 7. To enlarge the return air opening 21, the sleeve wall 18 of the hollow connecting sleeve 7 of the handpiece head 3 has at least one interruption 19 and/or at least one recess 20.

FIG. 5 shows a cross section through the medical or dental handpiece 1 along line R-R, together with a coupling sleeve 14 attached at the proximal end of the grip sleeve 2. The driving air tube 4, which is accommodated in the handpiece 1 by the grip sleeve 2 and has a tube piece 30 and a nozzle piece 9 has a plurality of channels 34 for a plurality of outlet openings of the driving air in the rotor receptacle 13 of the handpiece head 3. The intermediate space 21, which is formed by the hollow connecting sleeve 7 of the handpiece head 3 and the driving air tube 4, serves to return the driving air. The hollow connecting sleeve 7 with a first inside diameter H preferably has a second diameter A, which corresponds to the outside diameter D of the driving air tube 4, in particular of the second end of the nozzle piece 9 and together with the inside diameter H forms at least one contact face 15 for the driving air tube 4. The driving air tube 4 in this exemplary embodiment has a second diameter I, which is smaller than the inside diameter H of the hollow connecting sleeve of the handpiece head.

The invention is not limited to the exemplary embodiment described here, but instead includes all the embodiments which apply or comprise the basic function principle of the invention by analogy. In addition, all the features of all the exemplary embodiments described and presented here can be combined with one another.

What is claimed is:

1. A medical or dental handpiece, comprising:
a grip sleeve;
a handpiece head comprising a head housing and a hollow connecting sleeve extending from the head housing for connecting the handpiece head to the grip sleeve;
an engagement element having a first end positionable to extend through the grip sleeve and a second end engageable within an opening in the handpiece head; and
a retaining member spaced proximally from the handpiece head;
wherein the first end is connectable with the retaining member to secure the second end of the engagement element against the handpiece head and to retain the grip sleeve around the engagement element and against the handpiece head.

2. The medical or dental handpiece of claim 1, wherein the engagement element comprises a driving air tube.

3. The medical or dental handpiece of claim 1, further comprising a stop, and wherein a proximal end of the grip sleeve contacts the stop and prevents the grip sleeve from moving in at least the proximal direction when the second end of the engagement element is fully engaged with the retaining element.

4. The medical or dental handpiece of claim 1, wherein the opening in the handpiece head has a diameter, wherein the second end of the engagement element has a dimension larger than the diameter of the opening in the handpiece head, and wherein the second end of the engagement element engages a surface of the handpiece head defining the diameter when the engagement element is fully engaged with the retaining element.

5. The medical or dental handpiece head of claim 1, wherein the second end is wedge-shaped, and wherein engagement of the first end of the engagement element with the retaining member moves the second end toward the retaining element, thereby causing the wedge-shaped second end to positively bear upon the handpiece head.

6. The medical or dental handpiece according to claim 1, wherein the second end of the driving air tube is configured as a nozzle piece.

7. The medical or dental handpiece according to claim 6, wherein the nozzle piece has at least two outlet openings for driving air directable at a turbine drive mounted in the handpiece head.

8. The medical or dental handpiece according to claim 1, wherein the second end has an arc-shaped portion having at least two outlet openings and the handpiece head has a corresponding arc-shaped rotor receptacle, and wherein when the second end is assembled with the handpiece head, the arc-shaped portion of the handpiece head together with the arc-shaped rotor receptacle form a cyclindrical space shaped to receive a cylindrical rotor.

9. The medical or dental handpiece according to claim 1, wherein the grip sleeve of the handpiece is connectable to a coupling sleeve.

10. The medical or dental handpice according to claim 1, wherein the retainer element is positioned within the grip sleeve.

11. The medical or dental handpiece of claim 1, wherein the retainer element is configured to be positioned in a coupling sleeve located proximally of the grip sleeve.

12. The medical or dental handpiece of claim 1, wherein at least one contact face for the driving air tube is provided on the handpiece head, and at least one contact face for the handpiece head is provided on the driving air tube.

13. The medical or dental handpiece according to claim 12, wherein the at least one contact face on the handpiece head is formed by a setback, and the contact face of the driving air tube is formed as a protrusion, and wherein the protrusion is received in the setback when the driving air tube is fully engaged with the handpiece head.

14. The medical or dental handpiece according to claim 1, wherein a wall of the hollow connecting sleeve of the handpiece head has at least one interruption and/or at least one recess to enlarge the dimension of a return air opening around the nozzle piece mounted therein.

15. The medical or dental handpiece according to claim 1, wherein the first end of the engagement element is threaded.

16. The medical or dental handpiece according to claim 15, wherein the retainer element is configured as a disk-shaped carrier plate mounted against a stop and having an internal thread to receive the second end of the engagement element.

17. The medical or dental handpiece according to claim 1, wherein the engagement element comprises a first piece and a second piece, and wherein the driving air tube is the first piece and the second piece comprises a nozzle piece connected to a distal end of the driving air tube.

18. The medical or dental handpiece of claim 1, wherein when the handpiece is assembled, the handpiece head is held in position by a tension force exerted on the handpiece through the engagement element to a point on the handpiece spaced proximally from the handpiece head.

19. A method for assembling a medical or dental handpiece, comprising:
providing a grip sleeve, a handpiece head with a head housing and a hollow connecting sleeve, a engagement element having a first end, a second end and a driving air tube, and a retainer element spaced proximally from the handpiece head;
positioning the engagement element in the handpiece head by inserting the first end of the engagement element through the hollow connecting sleeve and causing the second end to bear against an inner surface of the connecting sleeve;
attaching the grip sleeve to the connecting sleeve of the handpiece head and positioning the grip sleeve around the engagement element;
connecting the retainer element to the first end of the engagement element; and
moving the engagement element relative to the retainer element to secure the handpiece head with the grip sleeve of the handpiece.

20. The method of claim 19, wherein the connecting the retainer element to the first end of the engagement element comprises engaging respective threads on the first end and on the retainer element.

21. The method of claim 19, wherein the second end of the engagement-element has an arc-shaped portion, and wherein positioning the engagement element in the handpiece head comprises positioning the arc-shaped second end adjacent a complementary arc-shaped portion of the handpiece head to form a generally cylindrical receptacle.
